(19) United States
(12) Patent Application Publication
(10) Pub. No.: US 2026/0338226 A1
(43) Pub. Date: Oct. 29, 2026

(54) THIN-SECTION BEARING UNIT

(71) Applicant: Aktiebolaget SKF, Goteborg (SE)

(72) Inventors: Andrea A. Bertonlini, Carrara (IT); Fausto BARACCA, Massa (IT); Dhanavel JOTHILINGAM, Erode (IN); Mohammed IKRAMUDDIN, Bidar (IN)

(21) Appl. No.: 19/546,922

(22) Filed: Feb. 23, 2026

(30) Foreign Application Priority Data
Feb. 28, 2025 (IT) 102025000004215

(51) Int. Cl. F16C 19/08; F16C 35/04

(52) U.S. Cl. CPC F16C 19/08; F16C 35/045; F16C 2322/34

(57) ABSTRACT

A thin section bearing unit (10) for multi-wire machines. The bearing unit has a central axis (X) of rotation. The bearing unit has a stationary radially inner ring (20), a rotatable radially outer ring (30), and first (41) and second rows (42) of axially adjacent rolling elements (40). The radially outer ring (30) has a supporting flange (60) extending radially outwards in a direction transverse to the axis (X). The supporting flange (60) is axially positioned at the center of the radially outer ring (30).

### CROSS-REFERENCE TO RELATED APPLICATION

This application claims priority to Italian Patent Application No. 102025000004215, filed Feb. 28, 2025, the entirety of which is hereby incorporated by reference.

### FIELD

The present disclosure is related to a thin-section bearing unit.

In particular, the present disclosure relates to a thin section bearing unit for multi-wire machines, to which the present disclosure will refer without losing its generality.

### BACKGROUND

In multi-wire machines, blocks of stone material, such as stone, marble, concrete conglomerates and similar, are cut into slabs by the action of diamond cutting wires, which are arranged parallel to each other along a cutting path, and are sent back along this path by tensioning pulleys. In order to produce slabs of even rather reduced thickness, the tensioning pulleys are assembled in a pack, on a common support shaft, one axially next to the other, and are made rotatable with respect to the support shaft itself by the interposition of respective thin-section bearing units. The thin-section bearing units of the known type for multi-wire machines are therefore also mounted in packs, one next to the other along a respective and common central axis of rotation defined by the support shaft, and although they have their respective external diameters of rather large dimensions, they must necessarily have decidedly reduced axial thicknesses to allow the tensioning pulleys to be mounted as close together axially as possible, and the combination of large diameters and reduced axial thicknesses makes it essential to use particularly sophisticated technical solutions to ensure consistently high performance.

Such bearing units comprise:
respective stationary inner rings, arranged axially close to each other;
respective rotating outer rings, which have, instead, an axial dimension slightly smaller than that of the respective inner rings in order to be able to rotate independently of each other and allow independent rotation of the respective tensioning pulleys;
one or two rows of rolling elements, preferably balls, placed between the respective raceways of the inner ring and the outer ring to allow their relative rotation, where the rolling elements are held in position by a pressed steel retaining cage that envelops the rolling elements on both axially opposite sides of the row; and
respective sealing shields arranged on the axially opposite sides of the row or rows of rolling elements and placed between the respective inner and outer rings both to prevent the entry into the bearing units themselves of contaminants such as, for example, water mixed with stone dust, and also to prevent the dispersion towards the outside of the internal lubricating grease.

Each outer ring has a respective supporting flange connected to a respective pulley, while each inner ring is laterally delimited by respective annular surfaces arranged directly in contact with the annular surfaces of the inner rings of the axially adjacent bearing units.

In all known solutions, the supporting flange of the marble cutting machine is positioned on one side of the bearing unit, regardless of whether the bearing unit has one or two rows of rolling elements. These known solutions present unbalanced conditions in terms of loads and vibrations that cause the diamond wire at the top of the pulley to oscillate. The more the diamond wire oscillates, the worse the quality of the final stone cut will be, resulting in a lot of dust and waste materials.

### SUMMARY

The aim of the present disclosure is to create a thin-section bearing unit that solves the above-mentioned drawbacks, to the full advantage of the production efficiency of the related multi-wire machines.

According to the present disclosure, a thin-section bearing unit for multi-wire machines is created having the characteristics set out in the attached claims.

### BRIEF DESCRIPTION OF THE DRAWINGS

The present disclosure will now be described with reference to the attached drawings, which illustrate a non-limiting example of its implementation, in which:

FIG. 1 is a partial cross-sectional view of a multi-wire machine comprising a thin-section bearing unit according to a preferred embodiment of the present disclosure;

FIG. 2 illustrates, in cross-section and on an enlarged scale, the thin-section bearing unit of FIG. 1; and

FIGS. 3 and 4 represent the force transmission scheme to a bearing unit, respectively, according to the state of the art (FIG. 3) and according to the present disclosure (FIG. 4).

### DETAILED DESCRIPTION

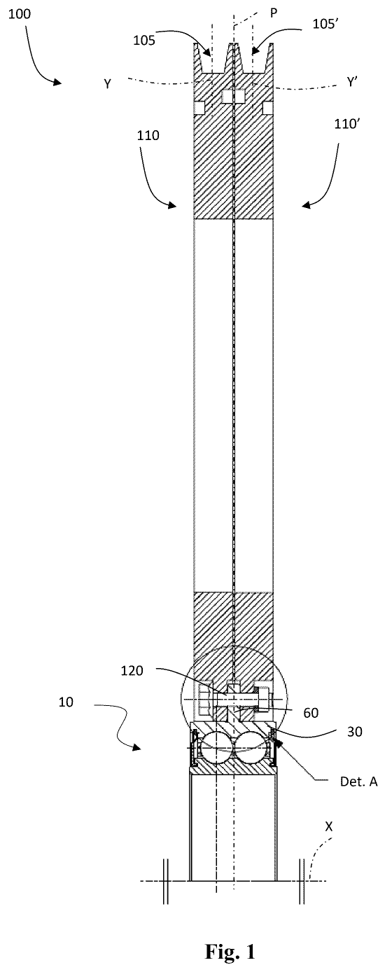

FIG. 1 shows a multi-wire machine for cutting stone blocks. More precisely, FIG. 1 shows a modular unit 100 of a multi-wire machine transmission unit.

The modular unit 100 comprises:
a thin-section bearing unit 10, having a double row of rolling elements and a central rotation axis X, and
a pair of pulleys 110, 110′, symmetrical to each other with respect to a plane P orthogonal to the axis X. The two pulleys 110, 110′ are integrally connected to the bearing unit 10 by means of a tightening element, for example a bolt 120. Each pulley 110, 110′ is provided with a respective groove 105, 105′ to house, in each of them, a diamond wire (for simplicity, the diamond wires are not illustrated but schematized with respective symmetry axes Y, Y′).

The bearing unit 10 has very limited axial dimensions to be able to be mounted, together with other identical bearing units in the return group of the multi-wire machine, where the group can include from two up to over one hundred (for example, from thirty to one hundred and fifteen) bearing units 10, all identical to each other and arranged side by side along the respective and common central axis X of rotation. The thin-section bearing unit 10 of the present disclosure finds advantageous application in multi-wire machines, to which the following discussion will refer, by way of example, without thereby losing generality. In these multi-wire machines, blocks of stone material are cut into slabs by means of diamond cutting wires arranged parallel to each other along the blocks themselves, and returned along such blocks by means of the tensioning pulleys 110, 110′. For the purpose of producing these slabs, these tensioning pulleys are assembled in a pack, one axially next to the other, on a common support shaft (not illustrated) defining the central axis X, and are made rotatable with respect to the support shaft thanks to the interposition of a respective bearing unit 10.

Throughout this description and in the claims, terms and expressions that indicate positions and directions such as for example “radial”, “axial”, “transversal”, are to be understood as referring to the axis X of rotation.

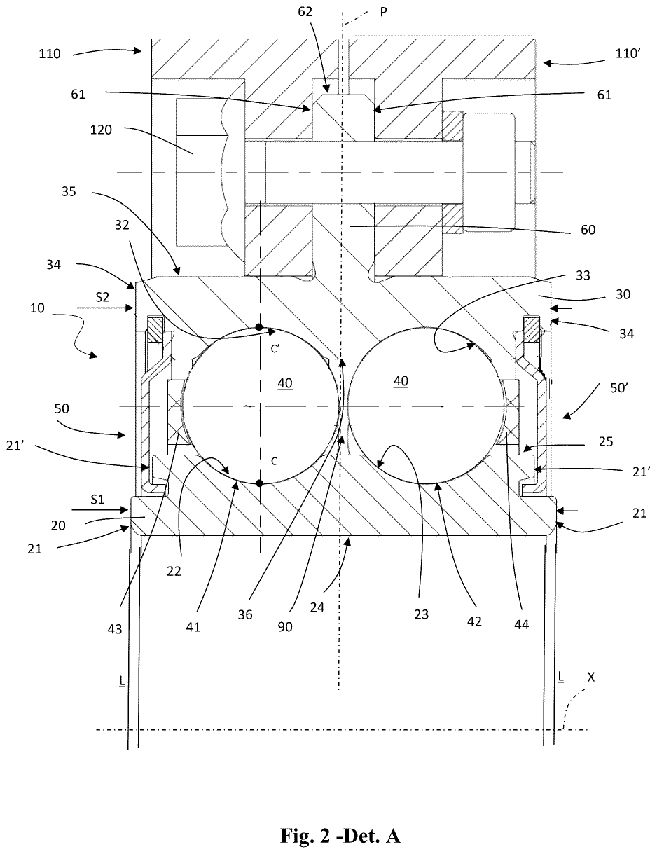

With reference to FIG. 2, the thin-section bearing unit is indicated as a whole with 10.

The bearing unit 10 comprises:
a stationary inner ring 20, mounted on a stationary shaft of the multi-wire machine;
a flanged outer ring 30, rotating, having an axial thickness S2 of dimensions smaller than the axial dimensions of an axial thickness S1 of the inner ring 20 and defining a cylindrical cavity 90 with the inner ring 20;
two rows 41, 42 of rolling elements 40;
two cages 43 and 44 for retaining the rolling elements 40;
two sealing shields 50, 50′ arranged on the axially opposite side of the bearing unit 10 and interposed between the inner ring 20 and the outer ring 30.

The inner ring 20 is provided with a first 22 and a second radially external raceway 23 for the sliding of the rolling elements 40 of the respective first 41 and second row 42. For each side L of the bearing unit 10, the inner ring 20 is axially delimited by two annular surfaces 21 and 21′ arranged in series from the outside of the bearing unit 10 towards the X axis and of which the two surfaces 21′ are axially recessed with respect to the surfaces 21. Furthermore, the inner ring 20 is radially delimited towards the inside by a cylindrical surface 24, coaxial to the X axis and orthogonal to the two annular surfaces 21, and radially towards the outside by a surface 25, also cylindrical, coaxial to the X axis and orthogonal to the two annular surfaces 21, surface 25 which includes the first 22 and the second raceway 23 of the inner ring 20.

The outer ring 30 is provided with a first 32 and a second radially internal raceway 33 for the sliding of the rolling elements 40 of the respective first 41 and second row 42. The raceways 32, 33 of the outer ring 30 are radially facing the respective raceways 22, 23 of the inner ring. Furthermore, the flanged outer ring 30, for each side L of the bearing unit 10, is axially delimited by an annular surface 34 orthogonal to the X axis. The flanged outer ring 30 is radially delimited towards the outside by a cylindrical surface 35, coaxial to the X axis and orthogonal to the annular surface 34, and radially towards the inside by a surface 36, also cylindrical, coaxial to the X axis and orthogonal to the annular surface 34, surface 36 which includes the first 32 and the second raceway 33 of the outer ring 30.

The two rows 41, 42 of rolling elements 40, preferably balls, are arranged inside the cavity 90 and interposed between the inner ring 20 and the outer ring 30 to allow their relative rotation around the axis X. More precisely, each ball 40 of the rows 41, 42 has two contact points C, C′ with the respective raceways (raceways 22, 32 for the balls of the row 41 and raceways 23, 33 for the balls of the row 42). According to an alternative embodiment, the contact points between each ball 40 of the rows 41, 42 and the respective raceways can be four, two for each raceway.

A first sealing shield 50 of the two sealing shields 50, 50′, is located axially outwards with respect to the first row 41 of rolling elements 40 and a second sealing shield 50′ is located axially outwards with respect to the second row 42 of rolling elements 40. The sealing shields 50, 50′ serve both to prevent the entry into the cavity 90 of the bearing unit 10 itself of contaminating materials such as, for example, water mixed with stone dust, and also to prevent the dispersion outwards of the lubricating grease contained within the cavity 90. The sealing shields 50, 50′ are mounted on the outer ring 30 and, therefore, are also rotatable.

According to the present disclosure, the outer ring 30 is provided with a support or supporting flange 60, which extends radially towards the outside of the outer ring 30 itself in a direction transverse to the axis X. Axially, the flange 60 is positioned exactly at the center of the radially outer ring 30, presenting the plane P as the plane of transverse symmetry.

The flange 60, for each side L of the bearing unit 10, is axially delimited by an annular surface 61 and orthogonal to the axis X and is radially delimited towards the outside by a cylindrical surface 62, coaxial to the axis X and orthogonal to the annular surface 61.

The flange 60 is made integrated with the radially outer ring 30. According to an alternative embodiment, the flange 60 can be a separate component, of a disc-shaped shape keyed and fixed on the radially outer ring according to known technologies, for example pressed with interference or welded.

The flange 60 is connected to each pulley 110, 110′ of the pair of pulleys of the modular unit 100. More precisely, the connection occurs by tightening to the flange 60, from each side L of the bearing unit 10, a respective portion 101, 101′, radially internal, of the pair of pulleys 110, 110′. As already mentioned, the tightening is guaranteed by a fastening element of a known type, for example the through bolt 120.

This solution is intended to better balance external loads and vibrations since the flange is positioned exactly in the center of the radially outer ring and, therefore, of the entire bearing unit. Obviously, this solution is not applicable to bearing units with a single row of balls since there would not be enough axial space to mount a pair of pulleys on the sides of the flange. Conversely, the double-row ball bearing unit allows the present solution according to which the flange is not positioned at one end of the outer ring, as according to the prior art, but exactly in the center.

With a flange 60 perfectly symmetrical with respect to the raceways 32, 33 of the radially outer ring 30 and the raceways 22, 23 of the radially inner ring 20 (regardless of the number of contact points between the balls and raceways, which can be either two or four), the loads on the bearing unit are perfectly balanced because the external loads that the pulleys transmit to the flange by means of the fastening element are symmetrical with respect to the bearing unit.

This symmetrical solution also allows for better balancing of the vibration and reduction of the oscillation of the bearing and the diamond wire in the groove 105, 105′ of the pulley 110, 110′. The reduction of the oscillation implies the reduction of the waste particles created during the cutting of the marble. This creates a better and more precise cut.

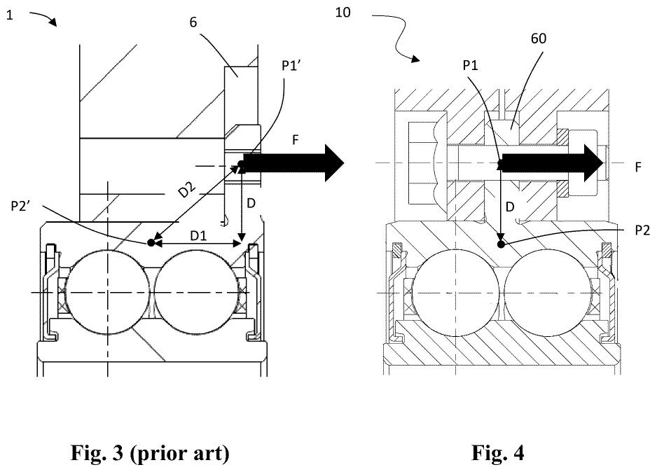

Furthermore, and with reference to FIGS. 3 and 4, it can be easily demonstrated that the moment applied to the bearing unit 10, with centered supporting flange 60, according to the present disclosure, is much reduced compared to that applied to the bearing unit 1, according to the known technique, with supporting flange 6 positioned at one end of the bearing unit.

The moment is calculated as force F multiplied by the distance between the point of application of the load P1′, P1 and the center of gravity P2′, P2 of the respective outer ring 3, 30.

In the case of the bearing unit 10 according to the present disclosure (FIG. 4), said:
F: applied load
D: distance between the point of application of the load P1 and the center of gravity P2 of the outer ring 30
M: resulting torque,
the value of the torque M is given by:

M=F×D

Instead, in the case of the bearing unit 1 according to the prior art (FIG. 3), said:
F: applied load
D2: distance between the point of application of the load P1 and the center of gravity P2 of the outer ring 3,
D: distance between the point of application of the load P1 and the center of gravity P2 of the outer ring 3 in the radial direction. This distance coincides with the distance between the point of application of the load P1 and the center of gravity P2 of the outer ring 30 of the bearing unit 10, according to the present disclosure. For this reason, the same reference D is used,
D1: distance between the point of application of the load P1 and the center of gravity P2 of the outer ring 3 in the axial direction,
M1: resulting torque,
the value of the torque M1 is given by:

M1=F×D2

Furthermore, from simple geometric considerations it results:

D2²=D²+D1²

Considering the geometry of the bearing unit 1, of known type, as a first approximation it is possible to consider the two distances D and D1 equal in the respective two radial and axial directions. Therefore, it will result:

D2=√2×D

Therefore, in the two cases analyzed, the ratio of the distances between the point of application of the load P1 and the center of gravity P2 of the outer ring is equal to the factor of √2. In other words, considering that there is a linear proportion between torque and distance, it can be concluded that by moving the supporting flange from the end to the center of the outer ring, the torque on the bearing unit is reduced by the factor √2, or approximately 30%.

As already mentioned, the solution according to the present disclosure implies, in a single modular unit of the multiwire machine, the presence of two pulleys instead of a single pulley. It should be considered, however, that in the known solutions in which the same bearing unit with two rows of rolling elements is used, the pulley used has substantially the same axial dimensions as the bearing unit and is provided with two grooves to house, in each of them, a diamond wire. So, while it is true that two pulleys are needed in the present solution, they are lighter than the single pulley in the known solution and simpler (they have only one groove instead of two). Furthermore, the two pulleys are symmetrical and interchangeable. Finally, if a pulley has to be scrapped (for example, due to wear and tear), the replacement cost will be lower than that of the single pulley with two grooves for the diamond wires.

The assembly procedure of the present solution is also advantageous. In fact, using this solution, the end user can assemble the pulley with the same working procedure as in the prior art, as there is enough space to be able to use the fastening element (for example, the bolt with its nut). Furthermore, since with this solution only one bolt is needed to fix two pulleys, the assembly process is simplified since the number of bolts to be tightened is halved.

Ultimately, the solution according to the present disclosure has numerous advantages:
it allows for a lower torque acting on the bearing unit compared to the known solutions. Consequently, it allows for a better balancing of the bearing unit with respect to external loads,
it allows for an increase in the life of the bearing,
it is applicable to bearing units with two or four contact points between rolling elements and sliding tracks,
it requires the same assembly procedure as the known solutions, but compared to them the assembly procedure is simplified.

In addition to the embodiment of the present disclosure, as described above, it is to be understood that numerous other variants exist. It is also to be understood that such embodiments are exemplary only and limit neither the scope of the present disclosure, nor its applications, nor its possible configurations. On the contrary, although the above description allows the skilled person to carry out the present disclosure at least according to an exemplary embodiment thereof, it must be understood that many variants of the components described are possible, without thereby departing from the scope of the present disclosure, as defined in the attached claims, which are interpreted literally and/or according to their legal equivalents.

What is claimed is:

1. A thin-section bearing unit for multi-wire machines, the bearing unit having a central rotation axis, the bearing unit comprising:
a stationary radially inner ring having first and second radially external raceways;
a rotatable radially outer ring having first and second radially internal raceways, the radially outer ring having a supporting flange extending radially outwards in a direction transverse to the axis, the supporting flange being axially positioned at a center of the radially outer ring;
a first row of rolling elements interposed between the first raceways of the radially inner ring and the radially outer ring; and
a second row of rolling elements axially adjacent the first row of rolling elements, the second row of rolling elements interposed between the second raceways of the radially inner ring and the radially outer ring.

2. The bearing unit according to claim 1, wherein each axial side of the flange is delimited by an annular surface orthogonal to the axis, the flange being radially delimited towards the outside by a cylindrical surface that is coaxial to the axis and is orthogonal to the annular surfaces.

3. The bearing unit according to claim 1, wherein the flange is integrated with the radially outer ring.

4. The bearing unit according to claim 1, wherein the flange has a discoid shape and is keyed and stably fixed on the radially outer ring.

5. The bearing unit according to claim 1, wherein each rolling element of the first and second rows has two contact points with the respective raceways.

6. The bearing unit according to claim 1, wherein each rolling element of the first and second rows has four contact points with the respective raceways.

7. The bearing unit according to claim 2, wherein the flange is integrated with the radially outer ring.

8. The bearing unit according to claim 2, wherein the flange has a discoid shape and is keyed and stably fixed on the radially outer ring.

9. The bearing unit according to claim 7, wherein each rolling element of the first and second rows has two contact points with the respective raceways.

10. The bearing unit according to claim 7, wherein each rolling element of the first and second rows has four contact points with the respective raceways.

11. A modular unit of a transmission unit of a multi-wire machine for cutting blocks of stone material, the modular unit comprising:
the thin-section bearing unit according to claim 1;
a pair of pulleys, symmetrical to one other with respect to a plane orthogonal to the axis; and
a fastening element integrally connecting the pair of pulleys to the bearing unit.

12. The modular unit according to claim 11, wherein the supporting flange of the bearing unit is connected, on each axial side, to a respective radially internal portion of each pulley of the pair of pulleys.
